(19) United States
(12) Patent Application Publication
(10) Pub. No.: US 2015/0203929 A1
(43) Pub. Date: Jul. 23, 2015

(54) METHOD FOR PRODUCING PIG IRON AND BLAST FURNACE FACILITY USING SAME

(71) Applicant: MITSUBISHI HEAVY INDUSTRIES, LTD., Tokyo (JP)

(72) Inventors: Setsuo Omoto, Tokyo (JP); Keiichi Nakagawa, Tokyo (JP); Tsutomu Hamada, Tokyo (JP); Masakazu Sakaguchi, Tokyo (JP)

(73) Assignee: MITSUBISHI HEAVY INDUSTRIES, LTD., Tokyo (JP)

(21) Appl. No.: 14/412,723

(22) PCT Filed: May 15, 2013
(86) PCT No.: PCT/JP2013/063504

§ 371 Date: Jan. 5, 2015

(30) Foreign Application Priority Data
Aug. 3, 2012 (JP) 2012-172757

(51) Int. Cl. C21B 5/00; F27B 1/20; F27B 1/16

(52) U.S. Cl. CPC C21B 5/003; F27B 1/16; C21B 5/008; F27B 1/20; F27M 2001/02; F27M 2001/045; F27M 2003/165

(57) ABSTRACT

This blast furnace facility is provided with: a blast furnace main body (110); starting material charging means (111-113) that charge a starting material (1) containing iron ore and coke into the interior of the blast furnace main body (110) from the apex thereof; hot airflow blow-in means (114, 115) that blows in a hot airflow (101) from a tuyere to the interior of the blast furnace main body (110); and blast-furnace-blow-in charcoal supply means (120-129) that blow in blast-furnace-blow-in charcoal (11) from the tuyere to the interior of the blast furnace main body (110). The blast-furnace-blow-in charcoal supply means (120-129) blow in a blast-furnace-blow-in charcoal (11) having an oxygen atom content (on a dry basis) of 10-20 wt % and an average pore size of 10-50 nm.

### TECHNICAL FIELD

The present invention relates to a method of manufacturing pig iron and a blast furnace installation to be used therein.

### BACKGROUND ART

Blast furnace installations are designed to be capable of manufacturing pig iron from iron ore by charging a raw material containing iron ore and coke into the blast furnace main unit through the top and blowing hot air and blast furnace injection coal (pulverized coal) as auxiliary fuel into the blast furnace main unit through the tuyeres on the lower lateral side thereof.

The blast furnace injection coal (pulverized coal) to be blown as auxiliary fuel into the blast furnace main unit through the tuyeres may generate unburned carbon (soot), in which case the unburned carbon may obstruct the flow of combusted gas. In view of this, Patent Literature 1 listed below, for example, proposes coal obtained adding an oxidant such as KMnO₄, H₂O₂, KClO₃, or K₂Cr₂O₄ to pulverized coal in advance to improve the combustion efficiency so that generation of unburned carbon (soot) can be suppressed.

Moreover, Patent Literature 2 listed below, for example, proposes a method which involves enriching the oxygen in hot air and blowing the air into a blast furnace main unit through its tuyeres to improve the combustibility of blast furnace injection coal.

### CITATION LIST

### Patent Literatures

Patent Literature 1: Japanese Patent Application Publication No. Hei 6-220510

### Patent Literature 2: Japanese Patent Application Publication No. 2003-286511

Patent Literature 3: Japanese Patent Application Publication No. Hei 10-060508
Patent Literature 4: Japanese Patent Application Publication No. Hei 11-092809

### SUMMARY OF INVENTION

### Technical Problems

However, the blast furnace injection coal described in Patent Literature 1 listed above inevitably requires adding the above-mentioned oxidant to pulverized coal and therefore increases the running cost.

Moreover, the combustibility improving method described in Patent Literature 2 listed above requires operating the blast furnace with a large amount of oxygen constantly added to the hot air and therefore increases the running cost as well.

In view of the above, an object of the present invention is to provide a method of manufacturing pig iron and a blast furnace installation to be used therein which are capable of reducing the manufacturing cost of pig iron.

### Solution to Problems

A method of manufacturing pig iron according to a first aspect of the invention for solving the above-mentioned problems is a method of manufacturing pig iron including charging a raw material containing iron ore and coke into a blast furnace main unit from a top thereof and blowing hot air and blast furnace injection coal into the blast furnace main unit from a tuyere thereof to thereby manufacture pig iron from the iron ore in the raw material, characterized in that the blast furnace injection coal has an oxygen atom content ratio (dry base) of between 10 and 20% by weight and an average pore size of between 10 and 50 nm.

A method of manufacturing pig iron according to a second aspect of the invention is the first aspect of the invention, characterized in that the blast furnace injection coal has a pore volume of between 0.05 and 0.5 cm³/g.

A method of manufacturing pig iron according to a third aspect of the invention is the first or second aspect of the invention, characterized in that the blast furnace injection coal has a specific surface area of between 1 and 100 m²/g.

Also, a blast furnace installation according to a fourth aspect of the invention for solving the above-mentioned problems is a blast furnace installation including a blast furnace main unit, raw material charging means for charging a raw material containing iron ore and coke into the blast furnace main unit from a top thereof, hot air blowing means for blowing hot air into the blast furnace main unit from a tuyere thereof, and blast furnace injection coal feeding means for feeding blast furnace injection coal into the blast furnace main unit from the tuyere, characterized in that the blast furnace injection coal feeding means blows in the blast furnace injection coal having an oxygen atom content ratio (dry base) of between 10 and 20% by weight and an average pore size of between 10 and 50 nm.

A blast furnace installation according to a fifth aspect of the invention is the fourth aspect of the invention, characterized in that the blast furnace injection coal feeding means blows in the blast furnace injection coal having a pore volume of between 0.05 and 0.5 cm³/g.

A blast furnace installation according to a sixth aspect of the invention is the fourth or fifth aspect of the invention, characterized in that the blast furnace injection coal feeding means blows in the blast furnace injection coal having a specific surface area of between 1 and 100 m²/g.

### Advantageous Effects of Invention

According to the methods of manufacturing pig iron and the blast furnace installations to be used therein according to the present invention, blast furnace injection coal having an oxygen atom content ratio (dry base) of 10 to 20% by weight and an average pore size of 10 to 50 nm is blown into the blast furnace main unit. That is, blast furnace injection coal in which tar producing groups such as oxygen-containing functional groups (such as carboxyl groups, aldehyde groups, ester groups, and hydroxyl groups) desorb and greatly decrease but decomposition (decrease) of the main skeletons (combustion components mainly containing C, H, and O) is greatly suppressed, is blown into the blast furnace main unit. Hence, when such blast furnace injection coal is blown into the blast furnace main unit together with hot air, the blast furnace injection coal can be completely combusted with almost no unburned carbon (soot) generated because many oxygen atoms are contained in the main skeletons and also because the large-sized pores allow the oxygen in the hot air to be easily spread to the inside and also significantly suppresses the production of tar. Thus, inexpensive low-rank coal such as subbituminous coal or brown coal can be used as the blast furnace injection coal. Accordingly, the manufacturing cost of pig iron can be reduced.

### BRIEF DESCRIPTION OF DRAWINGS

FIG. 1 is a schematic configuration diagram of a chief part of a main embodiment of a blast furnace installation according to the present invention.

FIG. 2 is a graph showing the relation between the temperature of subbituminous coal and the ratio of content of each of its oxygen-containing functional groups based on an infrared absorption spectrum of the subbituminous coal measured with its temperature raised under a nitrogen-containing atmosphere.

FIG. 3 is a graph showing the relation between the ratios of unburned carbon collected after present invention coal, dried coal, and conventional coal are combusted, and the concentrations of residual oxygen (excess oxygen concentrations) in combustion exhaust gases after the combustion.

FIG. 4 is a graph showing the relation between the excess oxygen ratio and the combustion temperature of complete combustion of each of the present invention coal and the conventional coal.

### DESCRIPTION OF EMBODIMENTS

Embodiments of a method of manufacturing pig iron and a blast furnace installation to be used therein according to the present invention will be described with reference to the drawings. However, the present invention is not limited only to the embodiments to be described below with reference to the drawings.

### Main Embodiment

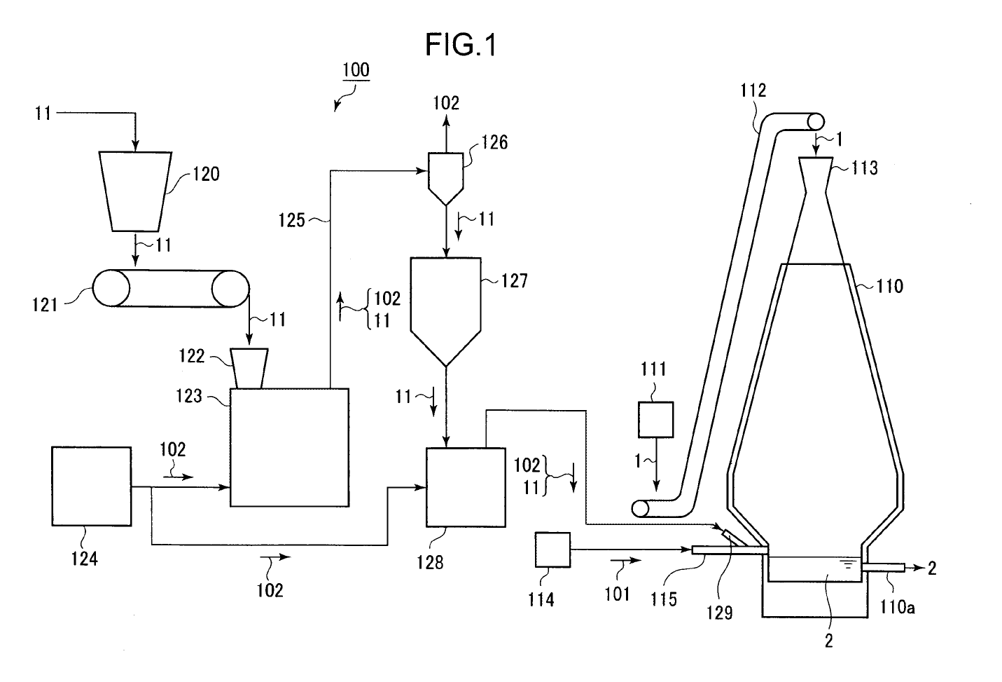

A main embodiment of the method of manufacturing pig iron and the blast furnace installation to be used therein according to the present invention will be described with reference to FIG. 1.

As shown in FIG. 1, a predetermined-amount raw material feed device 111 configured to feed a predetermined amount of a raw material 1 containing iron ore and coke communicates with the upstream side of a charge conveyer 112 in its transfer direction, the charge conveyer 112 being configured to transfer the raw material 1. The downstream side of this charge conveyer 112 in the transfer direction communicates with the upper side of a furnace top hopper 113 at the top of a blast furnace main unit 110. A hot air delivery device 114 configured to deliver hot air 101 (1000 to 1300° C.) communicates with a blow pipe 115 provided at each tuyere of the blast furnace main unit 110.

Moreover, in the vicinity of the blast furnace main unit 110, a feed hopper 120 is arranged which is configured to feed blast furnace injection coal 11. A lower portion of the feed hopper 120 communicates with the proximal end side of a belt conveyer 121 configured to transfer the blast furnace injection coal 11 coming out of the feed hopper 120. The distal end side of the belt conveyer 121 communicates with an upper portion of a receive hopper 122 configured to receive the blast furnace injection coal 11.

A lower portion of the receive hopper 122 is connected to a receive port in an upper portion of a coal mill 123 configured to pulverize the blast furnace injection coal 11 from the receive hopper 122 into predetermined sizes (e.g. 80 μm and smaller). A nitrogen gas feed source 124 configured to feed nitrogen gas 102 as inert gas is connected to the lower lateral side of the coal mill 123. The proximal end side of a transfer line 125 through which to transfer the pulverized blast furnace injection coal 11 with a stream of the nitrogen gas 102 is joined to the upper side of the coal mill 123.

The distal end side of the transfer line 125 is joined to a cyclone separator 126 configured to separate the blast furnace injection coal 11 and the nitrogen gas 102 from each other. The lower side of the cyclone separator 126 communicates with the upper side of a storage hopper 127 configured to store the blast furnace injection coal 11. A lower portion of the storage hopper 127 is connected to the upper side of an injection tank 128.

The nitrogen gas feed source 124 is connected to the lower lateral side of the injection tank 128. The upper side of the injection tank 128 is connected to an injection lance 129 connected to the blow pipe 115. By feeding the nitrogen gas 102 into the injection tank 128 from the nitrogen gas feed source 124, the blast furnace injection coal 11 fed to the inside of the injection tank 128 can be transferred by the stream and fed into the blow pipe 115 from the injection lance 129.

Note that reference sign 110a in FIG. 1 denotes a tap hole through which to take out molten pig iron (hot metal) 2.

In this embodiment described above, the predetermined-amount raw material feed device 111, the charge conveyer 112, the furnace top hopper 113, etc. serve as raw material charging means; the hot air delivery device 114, the blow pipe 115, etc. serve as hot air blowing means; and the feed hopper 120, the belt conveyer 121, the receive hopper 122, the coal mill 123, the nitrogen gas feed source 124, the transfer line 125, the cyclone separator 126, the storage hopper 127, the injection tank 128, the injection lance 129, the blow pipe 115, etc. serve as blast furnace injection coal feeding means.

The blast furnace injection coal 11 has an oxygen atom content ratio (dry base) of 10 to 18% by weight and an average pore size of 10 to 50 nm (preferably 20 to 50 nm).

The blast furnace injection coal 11 can be easily manufactured by: drying low-rank coal (oxygen atom content ratio (dry base): over 18% by weight, average pore size: 3 to 4 nm) such as subbituminous coal or brown coal by heating it (at 110 to 200° C.×0.5 to 1 hour) in a low oxygen atmosphere (oxygen concentration: 5% by volume or lower) to remove moisture; performing pyrolysis on the resultant coal by heating it (at 460 to 590° C. (preferably 500 to 550° C.)×0.5 to 1 hour) in a low oxygen atmosphere (oxygen concentration: 2% by volume or lower) to remove produced water, carbon dioxide, tar, and the like as pyrolysis gas and pyrolysis oil; and then cooling the resultant coal (to 50° C. or below) in a low oxygen atmosphere (oxygen concentration: 2% by volume or lower).

Next, a method of manufacturing pig iron using a blast furnace installation 100 described above will be described.

As the predetermined amount of the raw material 1 is fed from the predetermined-amount raw material feed device 111, the raw material 1 is fed into the furnace top hopper 113 by the charge conveyer 112 and charged into the blast furnace main unit 110.

In addition to this, as the blast furnace injection coal 11 is introduced into the feed hopper 120, the blast furnace injection coal 11 is fed into the receive hopper 122 by the belt conveyer 121 and pulverized by the coal mill 123 into predetermined sizes (e.g. 80 μm and smaller).

Then, as the nitrogen gas 102 is delivered from the nitrogen gas feed source 124, the stream of the nitrogen gas 102 transfers the pulverized blast furnace injection coal 11 through the transfer line 125 into the cyclone separator 126, in which the nitrogen gas 102 is separated from the blast furnace injection coal 11 and then discharged to the outside of the system.

The blast furnace injection coal 11 after the separation in the cyclone separator 126 is stored in the storage hopper 127 and then fed into the injection tank 128, from which the blast furnace injection coal 11 is transferred by a stream of the nitrogen gas 102 from the nitrogen gas feed source 124 into the injection lance 129 and fed into the blow pipe 115.

Thereafter, the hot air 101 is fed into the blow pipe 115 from the hot air delivery device 114 to pre-heat and ignite the blast furnace injection coal 11. As a result, the blast furnace injection coal 11 turns into a flame near the tip of the blow pipe 115 and combusted in a raceway, thereby reacting with the coke and the like in the raw material 1 and producing reduction gas. Accordingly, the iron ore in the raw material 1 is reduced and taken out as the pig iron (hot metal) 2 from the tap hole 110a.

Here, the blast furnace injection coal 11 has an average pore size of 10 to 50 nm, that is, tar producing groups such as oxygen-containing functional groups (such as carboxyl groups, aldehyde groups, ester groups, and hydroxyl groups) desorb and greatly decrease, while the blast furnace injection coal 11 has an oxygen atom content ratio (dry base) of 10 to 18% by weight, that is, decomposition (decrease) of the main skeletons (combustion components mainly containing C, H, and O) is greatly suppressed.

Hence, when the blast furnace injection coal 11 is blown into the blast furnace main unit 110 together with the hot air 101, the blast furnace injection coal 11 can be completely combusted with almost no unburned carbon (soot) generated because many oxygen atoms are contained in the main skeletons and also because the large-sized pores allow the oxygen in the hot air 101 to be easily spread to the inside and also significantly suppresses the production of tar.

Accordingly, it is possible to improve the combustion efficiency and suppress generation of unburned carbon (soot) without adding an oxidant such as KMnO₄, H₂O₂, KClO₃, or K₂Cr₂O₄ to the blast furnace injection coal or enriching the oxygen in the hot air.

Thus, according to this embodiment, inexpensive low-rank coal such as subbituminous coal or brown coal can be used as the blast furnace injection coal 11. Accordingly, bituminous coal or the like, which is expensive, does not have to be used as the blast furnace injection coal, and the manufacturing cost of the pig iron 2 can therefore be reduced.

Moreover, the oxygen atom content ratio of the blast furnace injection coal 11 (10 to 18% by weight on the dry base) is significantly larger than the oxygen atom content ratios of conventionally used, expensive bituminous coal and the like (several % by weight on the dry base). Thus, the amount of the hot air 101 to be fed can be reduced (by approximately 20%) as compared to the conventional cases, and the combustion temperature can therefore be higher than the conventionally used, expensive bituminous coal and the like even if the calorific value is smaller (see <No. 5> in [Examples] to be described later).

Accordingly, the hot air delivery pressure (blow-in pressure) of the hot air delivery device 114 can be reduced as compared to the conventional cases, and the power consumption of the hot air delivery device 114 can therefore be reduced as compared to the conventional cases.

On the other hand, in a case where the hot air 101 is fed in the same amount as those in the conventional cases, the amount of the blast furnace injection coal 11 to be fed can be larger (by approximately 20%) than those in the conventional cases. Thus, the amount of coke, which is expensive, to be charged as the raw material 1 into the blast furnace main unit 110 can be reduced. Accordingly, the manufacturing cost of the pig iron 2 can be reduced further.

Note that the average pore size of the blast furnace injection coal 11 needs to be 10 to 50 nm (preferably 20 to 50 nm). This is because if the average pore size is smaller than 10 nm, the spreadability of the oxygen in the hot air 101 to the inside will be deteriorated and the combustibility will be accordingly deteriorated. On the other hand, if the average pore size is larger than 50 nm, the blast furnace injection coal 11 will be easily crackable into smaller sizes due to heat shock and the like, and will therefore crack into smaller sizes when blown into the blast furnace main unit 110, which leads to a situation where the blast furnace injection coal 11 passes through the inside of the blast furnace main unit 110 with a gas stream and is discharged without combustion.

Moreover, the oxygen atom content ratio (dry base) of the blast furnace injection coal 11 needs to be 10% by weight or larger as well. This is because it will be difficult to achieve complete combustion without adding an oxidant or enriching the oxygen in the hot air if the oxygen atom content ratio (dry base) is smaller than 10% by weight.

Furthermore, the pore volume of the blast furnace injection coal 11 is preferably 0.05 to 0.5 cm³/g and particularly preferably 0.1 to 0.2 cm³/g. This is because the surface area of contact (surface area of reaction) with the oxygen in the hot air 101 will be small and the combustibility will possibly be deteriorated if the pore volume is smaller than 0.05 cm³/g, whereas large amounts of components will volatilize and the blast furnace injection coal 11 will be so porous that the combustion components may be excessively reduced if the pore volume is larger than 0.5 cm³/g.

In addition, the specific surface area of the blast furnace injection coal 11 is preferably 1 to 100 m²/g and particularly preferably 5 to 20 m²/g. This is because the surface area of contact (surface area of reaction) with the oxygen in the hot air 101 will be small and the combustibility will possibly be deteriorated if the specific surface area is smaller than 1 m²/g, whereas large amounts of components will volatilize and the blast furnace injection coal 11 will be so porous that the combustion components may be excessively reduced if the specific surface area is larger than 100 m²/g.

Meanwhile, in the manufacturing of the blast furnace injection coal 11, the temperature of the pyrolysis needs to be 460 to 590° C. (preferably 500 to 550° C.). This is because, the tar producing groups such as oxygen-containing functional groups will fail to be desorbed sufficiently from the low-rank coal and it will be extremely difficult to obtain an average pore size of 10 to 50 nm if the temperature is lower than 460° C., whereas the decomposition of the main skeletons (combustion components mainly containing C, H, and O) of the low-rank coal will start to be remarkable, and large amounts of components will volatilize, which in turn excessively reduces the combustion components, if the temperature is higher than 590° C.

### Another Embodiment

The above embodiment has described the case of utilizing the blast furnace injection coal 11 having an oxygen atom content ratio (dry base) of 10 to 18% by weight and an average pore size of 10 to 50 nm (preferably 20 to 50 nm) which is obtained by: heating low-rank coal (oxygen atom content ratio (dry base): over 18% by weight, average pore size: 3 to 4 nm) such as subbituminous coal or brown coal in a low oxygen atmosphere; performing pyrolysis on the resultant coal by heating it in a low oxygen atmosphere; and then cooling the resultant coal in a low oxygen atmosphere. However, as another embodiment, blast furnace injection coal 21 having an oxygen atom content ratio (dry base) of 12 to 20% by weight and an average pore size of 10 to 50 nm (preferably 20 to 50 nm) can be utilized which is obtained, for example, by: drying the above-mentioned low-rank coal (oxygen atom content ratio (dry base): over 18% by weight) in a similar manner to the above embodiment; performing pyrolysis on the resultant coal in a similar manner to the above embodiment; cooling the resultant coal (to 50 to 150° C.) in a low oxygen atmosphere (oxygen concentration: 5% by volume or lower); and then exposing the resultant coal to an oxygen-containing atmosphere (oxygen concentration: 5 to 21% by volume) (at 50 to 150° C.×0.5 to 10 hours) to let the coal chemically adsorb oxygen and be partially oxidized.

As in the above embodiment, this blast furnace injection coal 21 has an average pore size of 10 to 50 nm, that is, tar producing groups such as oxygen-containing functional groups (such as carboxyl groups, aldehyde groups, ester groups, and hydroxyl groups) desorb and greatly decrease, while the blast furnace injection coal 21 has an oxygen atom content ratio (dry base) of 12 to 20% by weight, that is, decomposition (decrease) of the main skeletons (combustion components mainly containing C, H, and O) is greatly suppressed. In addition, even more oxygen atoms are chemically adsorbed. Hence, when the blast furnace injection coal 21 is blown into a blast furnace main unit 110 together with hot air 101, the blast furnace injection coal 21 can be completely combusted with less generation of unburned carbon (soot) than that in the above embodiment because more oxygen atoms are contained in the main skeletons than those in the above embodiment and also because the large-sized pores allow the oxygen in the hot air 101 to be easily spread to the inside and also significantly suppresses the production of tar as in the above embodiment.

Accordingly, it is possible to improve the combustion efficiency and suppress generation of unburned carbon (soot) to greater extents than the above embodiment does without adding an oxidant such as KMnO₄, H₂O₂, KClO₃, or K₂Cr₂O₄ to the blast furnace injection coal or enriching the oxygen in the hot air.

Thus, the blast furnace injection coal 21 can reduce the manufacturing cost of pig iron 2 to a greater extent than does the blast furnace injection coal 11 of the above embodiment.

Here, the oxygen atom content ratio (dry base) of the blast furnace injection coal 21 needs to be 20% by weight or smaller. This is because the oxygen content will be excessively large and the calorific value will be excessively reduced if the oxygen atom content ratio (dry base) is larger than 20%.

Meanwhile, in the manufacturing of the blast furnace injection coal 21, the temperature of the above-mentioned partial oxidation process is preferably 50 to 150° C. This is because the partial oxidation process will be retarded even in an air atmosphere (oxygen concentration: 21% by volume) if the temperature is lower than 50° C., whereas large amounts of carbon monoxide and carbon dioxide may possibly be produced due to combustion reaction even in an atmosphere with an oxygen concentration of about 5% by volume if the temperature is higher than 150° C.

### EXAMPLES

Examples carried out for the purpose of confirming the advantageous effects of the method of manufacturing pig iron and the blast furnace installation to be used therein according to the present invention will be described below. However, the present invention is not limited only to the examples to be described below based on various kinds of data.

### <No. 1: Composition Analysis on Blast Furnace Injection Coal>

A composition analysis (ultimate analysis) was performed on the blast furnace injection coal 11 used in the main embodiment (present invention coal). Moreover, for comparison, a composition analysis was performed also on conventional blast furnace injection coal (PCI coal: conventional coal), and on coal obtained by omitting the pyrolysis step in the main embodiment (dried coal). Table 1 given below shows the results. Note that the values are all on the dry base.

TABLE 1

| | Present Invention | Conventional | |
|---|---|---|---|
| | Coal | Coal | Dried Coal |
| C (wt. %) | 73.8 | 84.5 | 71.0 |
| H (wt. %) | 3.2 | 3.8 | 3.6 |
| O (wt. %) | 14.4 | 2.9 | 18.5 |
| N (wt. %) | 1.1 | 1.7 | 1.0 |
| S (wt. %) | 0.3 | 0.5 | 0.5 |
| Calorific Value | 6700 | 8020 | 6300 |
| (kcal/kg) | | | |

As can be seen from Table 1 given above, the oxygen (O) ratio of the present invention coal is smaller than that of the dried coal and significantly larger than that of the conventional coal, while the carbon (C) ratio is larger than that of the dried coal and smaller than that of the conventional coal. Thus, the calorific value of the present invention coal is larger than that of the dried coal and smaller than that of the conventional coal.

### <No. 2: Surface States of Blast Furnace Injection Coal>

Surface states (average pore size, pore volume, specific surface area) of the above present invention coal were measured. Moreover, for comparison, the surface states of the above conventional coal and dried coal were measured as well. Table 2 given below shows the results.

TABLE 2

| | Present Invention | Conventional | |
|---|---|---|---|
| | Coal | Coal | Dried Coal |
| Average | 20 | 1.5 | 3.5 |
| Pore Size (nm) | | | |
| Pore Volume | 0.13 | 0.08 | 0.14 |
| (cm³/g) | | | |
| Specific | 10.4 | 0.23 | 15 |
| Surface Area | | | |
| (m²/g) | | | |

As can be seen from Table 2 given above, the average pore size of the present invention coal is significantly larger than those of the conventional coal and the dried coal.

### <No. 3: Amounts of Oxygen-Containing Functional Groups in Subbituminous Coal>

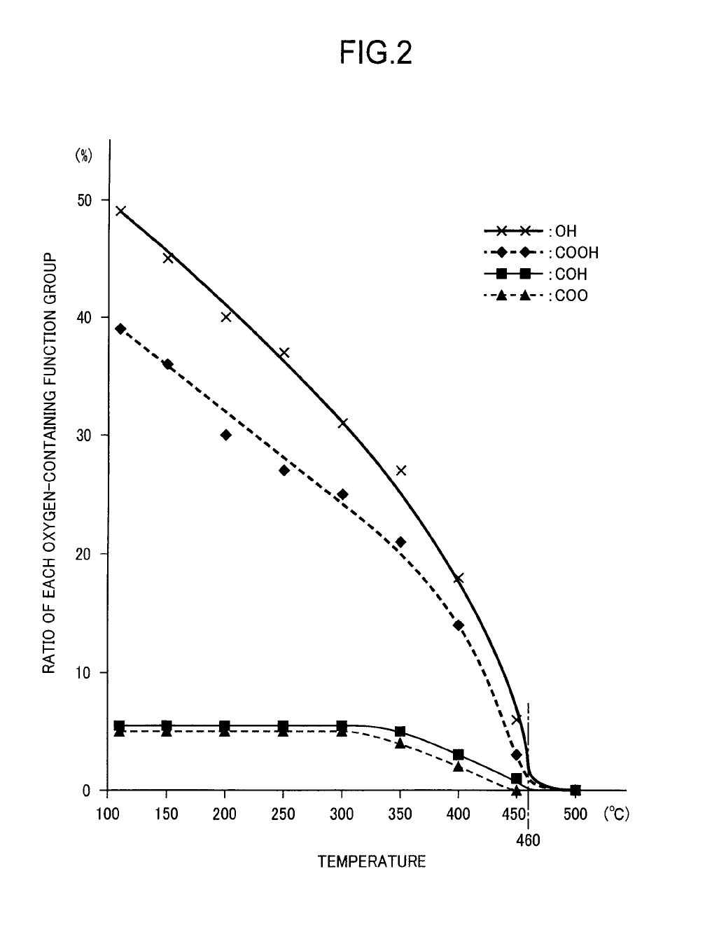

An infrared absorption spectrum of subbituminous coal (PRB coal from the United States) was measured with its temperature raised (10° C./min) under a nitrogen-containing atmosphere to find the ratio of the content of each of oxygen-containing functional groups (hydroxyl groups (OH), carboxyl groups (COOH), aldehyde groups (COH), ester groups (COO)) at given temperatures. FIG. 2 shows the result. Note that the horizontal axis represents the temperature, and the vertical axis represents the ratio of the peak area of each oxygen-containing functional group to the whole peak area of the oxygen-containing functional groups at 110° C.

As can be seen from FIG. 2, the above oxygen-containing functional groups, i.e. the tar producing groups are confirmed to mostly disappear at 460° C. and completely disappear at 500° C.

### <No. 4: Combustibility of Blast Furnace Injection Coal>

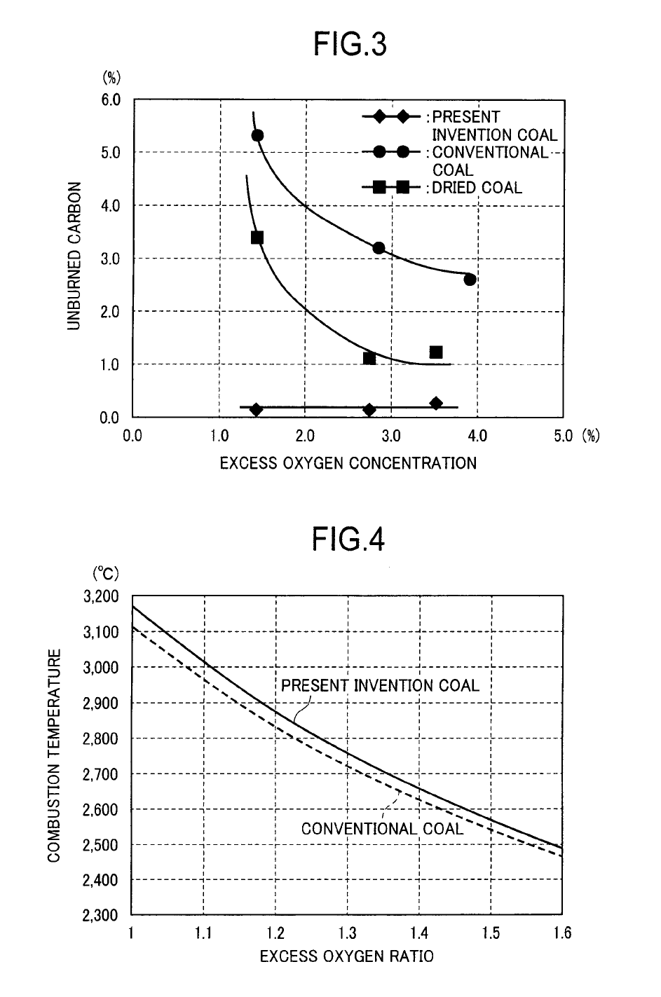

The relation between the ratio of residual unburned carbon resulting from combustion of the above present invention coal with air at 1500° C., and the flow rate of the fed air was found. Moreover, for comparison, the relation was found also for the above conventional coal and dried coal. FIG. 3 shows the results. Note that in FIG. 3, the horizontal axis represents the concentration of residual oxygen in combustion exhaust gas after the combustion of the coal, i.e. excess oxygen concentration, and the vertical axis represents the ratio of unburned carbon collected after the combustion of the coal.

As can be seen from FIG. 3, in the cases of the conventional coal and the dried coal, the amount of unburned carbon gradually increases as the excess oxygen concentration decreases. In contrast, in the case of the present invention coal, the amount of unburned carbon does not increase even when the excess oxygen concentration decreases. Thus, the present invention coal is confirmed to be capable of substantially complete combustion.

### <No. 5: Combustion Temperature of Blast Furnace Injection Coal>

The relation between the excess oxygen ratio and the combustion temperature of 100% complete combustion of the above present invention coal under the conditions given below was found. Moreover, for comparison, the relation was found also for the above conventional coal. FIG. 4 shows the results. Note that an excess oxygen ratio Os is a value defined by the formula (1) given below.

Combustion Formulas

C+O₂→CO₂

H₂+½O₂→H₂O

Combustion Conditions
Temperature of fed air: 1200° C.
Concentration of oxygen in air: 21 vol. %
Temperature of fed coal: 25° C.
Moisture content: 2%

Excess oxygen ratio Os==(Oa+Oc/2)/(Cc+Hc/4) (1)

where Oa is the molar flow rate of the oxygen gas (molecules) in the fed air, Oc is the molar flow rate of the oxygen atoms in the fed coal, Cc is the molar flow rate of the carbon atoms in the fed coal, and Hc is the molar flow rate of the hydrogen atoms in the fed coal.

As can be seen from FIG. 4, although the calorific value of the present invention coal is smaller than that of the conventional coal, the combustion temperature is confirmed to be higher than that of the conventional coal in a case where the excess oxygen ratio is the same as that of the conventional coal. This is because the present invention coal has a larger oxygen content ratio than the conventional coal does, and therefore only requires a smaller amount of fed air than the conventional coal does on condition that the excess oxygen ratio is the same as that of the conventional coal.

### INDUSTRIAL APPLICABILITY

The method of manufacturing pig iron and the blast furnace installation to be used therein according to the present invention can reduce the manufacturing cost of pig iron and can therefore be utilized significantly beneficially in the steel industry.

### REFERENCE SIGNS LIST

1 RAW MATERIAL
2 PIG IRON (HOT METAL)
11, 21 BLAST FURNACE INJECTION COAL
100 BLAST FURNACE INSTALLATION
101 HOT AIR
102 NITROGEN GAS
110 BLAST FURNACE MAIN UNIT
110a TAP HOLE
111 PREDETERMINED-AMOUNT RAW MATERIAL FEED DEVICE
112 CHARGE CONVEYER
113 FURNACE TOP HOPPER
114 HOT AIR DELIVERY DEVICE
115 BLOW PIPE
120 FEED HOPPER
121 BELT CONVEYER
122 RECEIVE HOPPER
123 COAL MILL
124 NITROGEN GAS FEED SOURCE
125 TRANSFER LINE
126 CYCLONE SEPARATOR
127 STORAGE HOPPER
128 INJECTION TANK
129 INJECTION LANCE

1. A method of manufacturing pig iron, comprising: charging a raw material containing iron ore and coke into a blast furnace main unit from a top thereof and blowing hot air and blast furnace injection coal into the blast furnace main unit from a tuyere thereof to thereby manufacture pig iron from the iron ore in the raw material, wherein
the blast furnace injection coal has an oxygen atom content ratio (dry base) of between 10 and 20% by weight and an average pore size of between 10 and 50 nm.

2. The method of manufacturing pig iron according to claim 1, wherein the blast furnace injection coal has a pore volume of between 0.05 and 0.5 cm³/g.

3. The method of manufacturing pig iron according to claim 1, wherein the blast furnace injection coal has a specific surface area of between 1 and 100 m²/g.

4. A blast furnace installation, comprising:
a blast furnace main unit;
raw material charging means for charging a raw material containing iron ore and coke into the blast furnace main unit from a top thereof;
hot air blowing means for blowing hot air into the blast furnace main unit from a tuyere thereof; and
blast furnace injection coal feeding means for feeding blast furnace injection coal into the blast furnace main unit from the tuyere, wherein
the blast furnace injection coal feeding means blows in the blast furnace injection coal having an oxygen atom content ratio (dry base) of between 10 and 20% by weight and an average pore size of between 10 and 50 nm.

5. The blast furnace installation according to claim 4, wherein the blast furnace injection coal feeding means blows in the blast furnace injection coal having a pore volume of between 0.05 and 0.5 cm³/g.

6. The blast furnace installation according to claim 4, wherein the blast furnace injection coal feeding means blows in the blast furnace injection coal having a specific surface area of between 1 and 100 m²/g.
